(19) United States
(12) Patent Application Publication
(10) Pub. No.: US 2013/0145665 A1
(43) Pub. Date: Jun. 13, 2013

(54) REMOVABLE LABEL FOR CONTAINERS

(71) Applicants: Noel Mitchell, Wuppertal (DE); Markus Kivelä, Tampere (FI)

(72) Inventors: Noel Mitchell, Wuppertal (DE); Markus Kivelä, Tampere (FI)

(73) Assignee: UPM RAFLATAC OY, Tampere (FI)

(21) Appl. No.: 13/704,475

(22) PCT Filed: Jun. 23, 2011
(86) PCT No.: PCT/FI2011/050608

§ 371 Date: Feb. 15, 2013

Related U.S. Application Data
(60) Provisional application No. 61/358,049, filed on Jun. 24, 2010.

(51) Int. Cl. G09F 3/10

(52) U.S. Cl. CPC G09F 3/10
USPC 40/638; 156/60; 156/250

(57) ABSTRACT

The invention relates to removable labels having a facestock layer, wherein another side of the facestock layer is overlaminated by a plastic film layer including regenerated cellulose. The invention also relates to a method for manufacturing such labels and to a method of labelling recyclable or re-usable containers.

### FIELD OF THE INVENTION

The present invention relates to a label laminate web for labels used, for example in reusable containers. More specifically, the invention relates to new type of pressure sensitive laminate construction for wash-off label products comprising a film derived from renewable sources.

### BACKGROUND OF THE INVENTION

It is general practice to apply labels to the surface of the containers, such as bottles from polymer or glass, to provide decoration, identification, and/or information such as contents of the container. Plastic labels, in contrast to paper labels, are increasingly preferred, for example, due to their more appealing appearance and better mechanical properties. The containers, such as bottles in the beverage industry, are generally reused many times and thus there is a need for plastic labels which are easily and completely removed from the surface of the container during the conventional washing processes such as dilute caustic soda heated to 50-90° C.

U.S. Pat. No. 6,680,097 discloses a self-adhesive film label, in particular for reusable bottles, which can be readily detached in conventional washing equipment. This is achieved by means of a self-adhesive label with a stretched film layer, which shrinks back at elevated temperatures in the washing device. Since the adhesive of the label loses its adhesive force at this temperature, the label is rapidly and readily detached, supported by the surrounding washing liquid of the washing device.

The major deficiencies of these type constructions are that they are rather costly and in addition in some cases they are using environmentally unfriendly PVC solutions.

### SUMMARY OF THE INVENTION

It is an object to provide more economical and environmentally friendly laminate construction for wash-off labels used in labelling of reusable containers, such as glass or plastic bottles. It is an object to provide a label which is easy to wash off during washing process. It is an object of the present invention to provide a method for producing said laminated constructions and labels thereof.

According to a first aspect of the present invention there is provided a removable label comprising a facestock layer and an adhesive layer against one side of the facestock layer, wherein the another side of the facestock layer may be overlaminated by a plastic film layer comprising at least 60 weight-% of regenerated cellulose.

According to a second aspect of the invention there is provided a method for producing a laminated label structure. The method may comprise combining an adhesive layer to a release liner and to one side of a face material layer, overlaminating another side of the face material layer by a plastic film layer comprising regenerated cellulose to form a laminated label structure.

According to a third a aspect of the invention there is provided a use of the label for labelling re-cyclable or re-usable articles.

Further embodiments of the invention are presented in the dependent claims.

The plastic film layer of the label may comprises at least 85 weight-% of regenerated cellulose. The plastic film layer may comprises at least 95 weight-% of regenerated cellulose. The plastic film layer may be oriented.

The regenerated cellulose of the plastic film layer may be based on viscose process. The regenerated cellulose may be cellophane.

The facestock layer of the label may comprise a biaxially oriented polypropylene film having a thickness from 15 to 50 microns, preferably 25 microns, and most preferably 20 microns or less.

The plastic film layer may have shrinkage of less than 5%, preferably less than 3% and most preferably from 1 to 2% in a machine direction of the label.

The plastic film layer may have expansion from 1 to 5%, preferably from 2 to 4%, and most preferably from 2.5 to 3.5% in a cross direction of the label.

The shrinkage of the plastic film in washing conditions having temperature of 66° C. and 4.5% NaOH may be from 50 to 120%, preferably from 65 to 110%, and most preferably from 75 to 100% from the shrinkage of the plastic film in washing conditions having temperature of 80° C. and 1.5% NaOH.

The label may have expansion from 0 to 5%, preferably from 0 to 3.5%, and most preferably from 0.2-1.5%.

The shrinkage of the label in washing conditions having temperature of 66° C. and 4.5% NaOH may be from 50 to 200%, preferably from 65 to 190%, and most preferably from 75 to 180% from the shrinkage of the label in washing conditions having temperature of 80° C. and 1.5% NaOH.

The label may have an average shrinkage of the machine direction and cross direction less than 1%.

### DESCRIPTION OF THE DRAWINGS

FIG. 1a shows, in a cross-sectional view, a label laminate web,

FIG. 1b shows, in a cross-sectional view, a laminate web comprising die-cut labels,

FIG. 1c shows, in a cross-sectional view, individual labels released from the release liner,

FIG. 2a shows, in a side view, a label attached to the surface of an article,

FIG. 2b shows, in a front view, application of a label to an article,

FIG. 2c shows, in a side view, a label removed from the article.

### DETAILED DESCRIPTION OF THE INVENTION

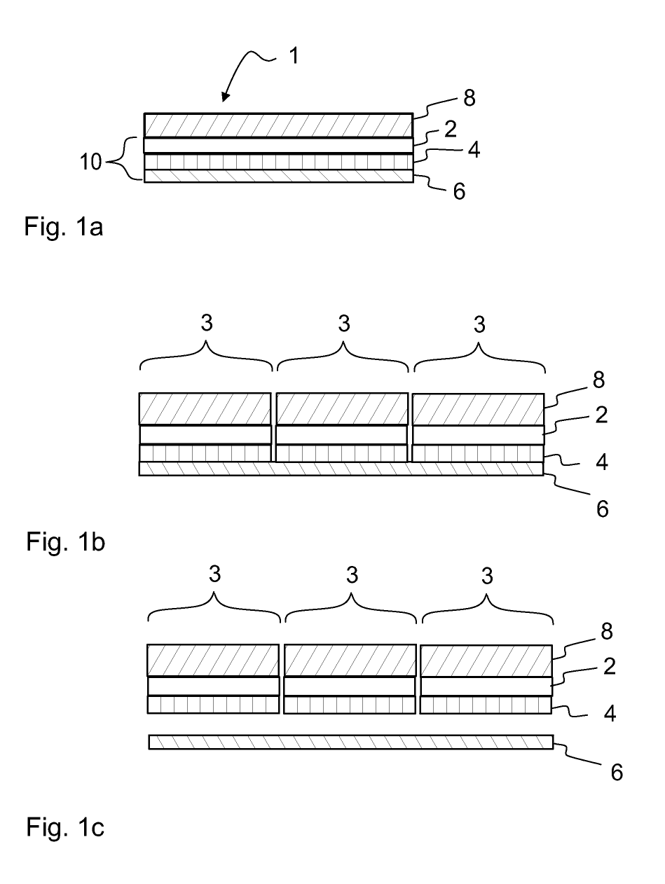

Referring to the FIG. 1a, a laminated label structure, also referred to a label laminate web structure 1, may comprise a facestock layer 2, an adhesive layer 4, and a release liner 6. This kind of structure will be designated also as a base structure 10. The release liner 6 may be coated with a thin layer of releasing agent, such as a silicone polymer. Subsequently the release liner may be coated with a pressure-sensitive adhesive and dried under heat in an oven and further combined with a facestock layer. Alternatively, the adhesive layer may be applied on the facestock prior to combining with the release liner.

The label laminate web may comprise a synthetic liner, preferably polyester, on to one side of which a coating of release agent, preferably silicone, is applied. This release liner is then further coated with an adhesive to which a polypropylene film is laminated. A thickness of the polypropylene may be from 15 to 50 microns, preferably 25 microns, and most preferably 20 microns or less. The polypropylene film may be oriented, preferably biaxially oriented (BOPP). PP film may be oriented from 4 to 7 times, preferably from 5 to 6 times in machine direction and from 6 to 10 times, preferably from 8 to 10 times in CD direction. Base structure 3 is further overlaminated by a regenerated cellulose film 8. The cellulosic film (8) may comprise at least 60 weight-% of regenerated cellulose, preferably at least 85 weight-%, preferably at least 95 weight-% and most preferably at least 98 wt-%. Cellulosic films comprising substantially only regenerated cellulose are preferred due to the good optical properties of the film, i.e. clear films may be achieved. The regenerated cellulose film is oriented, preferably biaxially oriented. The film may be oriented from 2 to 15 times, preferably from 3 to 10 times and most preferably from 4 to 7 times in machine direction (MD). The film may be oriented from 2 to 15 times, preferably from 3 to 10 times and most preferably from 4 to 7 times in cross direction (CD). The thickness of the polyester liner may be 25 microns, polypropylene film 25 microns and regenerated cellulose film 45 microns.

A part of a laminate web structure comprising a polypropylene film and a regenerated cellulose film can be designated also as a composite facestock layer. The composite facestock layer is preferably clear, i.e. substantially transparent to visible light. The clear facestock layer is preferred thus it allows the objects beneath such layer. The composite facestock has a haze less than 25%, preferably less than 15%, and most preferably less than 10% (according to standard ASTM D1003).

A regenerated cellulose polymer film may be derived from renewable, natural cellulose sources, such as from wood or cotton. Preferably regenerated cellulose films are produced through xanthation process of dissolved cellulose pulp. Also enzyme-aided processes may be used. For example, regenerated cellulose film may be based on viscose process. Regenerated cellulose film may comprise, for example viscose or cellophane (cellulose hydrate).

A laminate web may comprise graphic patterns, in order to provide visual effect and/or in order to display information. The laminate web base structure 3 may be printed directly on the polypropylene film 2 by any of the known printing methods, however preferably by gravure or flexographic processes. After printing, the polypropylene film is overlaminated with a regenerated cellulose film 8. Thickness of the regenerated cellulose film may be from 20 to 50 microns, preferably 45 microns. Alternatively, the regenerated cellulose film 8 may be printed on the reverse-side instead of printing on the surface of the polypropylene film. Then this printed side of the regenerated cellulose film is laminated to the base polypropylene construction with a laminating adhesive, preferably of polyurethane basis. Printing may also be arranged both on the polypropylene film 2 and the regenerated cellulose film 8 which are then laminated together. In some applications, two different printing layers may be beneficial, and permit use of different type of printing methods and/or inks.

The laminate web 1 may also comprise additional layers, such as sublayers, for example additional adhesive layer(s), tie layer(s) or protective layer(s).

Referring to the FIG. 1b, individual labels 3 may be cut from the laminate web 1. After cutting, the labels may be attached to a liner 6, which remains uncut. Thus, plurality of individual labels may be attached to a continuous liner. Alternatively, the individual labels 3 may be completely separate, i.e. also the liner 6 may be cut.

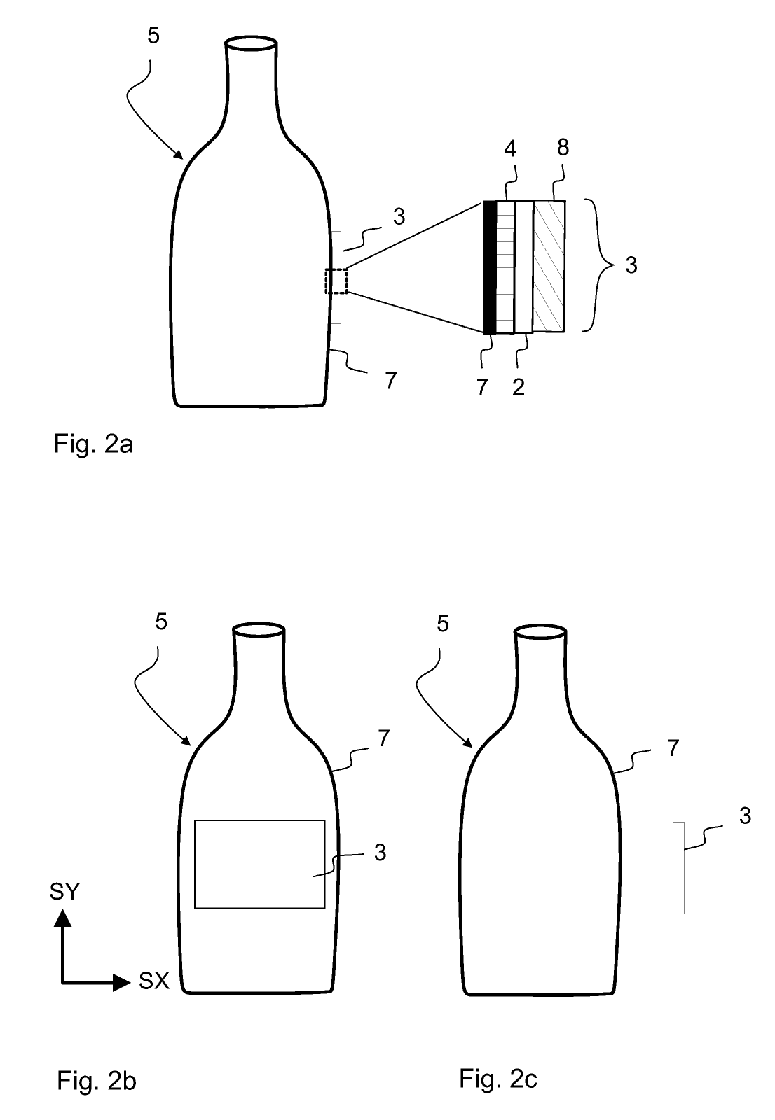

Referring to the FIG. 1c, the label 3 may be separated from the liner. Thus, a surface of the adhesive layer 4 may be exposed so that said label can be attached to an article 5, as shown in the FIG. 2a. The adhesive layer 4 may be in direct contact with the surface 7 of an article, such as a bottle.

Referring to the FIG. 2b, normal practice is to apply labels to articles, such as bottles, with the machine direction of the plastic film extending around the bottle in the direction SX. The direction of PP film and regenerated cellulose film of the label is preferably the same.

The label may be a pressure sensitive adhesive label (PSA), i.e. the adhesive layer comprises a pressure sensitive adhesive. PSA labels are adhered to the surface of an article through said adhesive layer forming a bond when pressure is applied on the label at room temperature. PSA labels may also be called as self-adhesive labels or self stick labels.

The adhesive used is such that the label is capable of being washed off during washing process of an article. Preferably the adhesive is such that under the influence of the washing liquid and temperature it loses its adhesivity to some degree but does not become soluble into the washing liquid. Therefore, the washing liquid does not become contaminated with the adhesive.

As defined herein, removability or wash off capability of a label, refers to the capability of the label to be removed from an article in a solution, e.g. warm caustic washing solution during the re-using process of the labelled article. Ideally, the label of an article is completely removed with no residue being left on the surface of the article. Additionally, the short amount of time the labelled article must remain in washing solution before the label is removed is preferred.

Referring to the FIG. 2c, the label 3 is washed off i.e., removed from the surface 7 of an article. Label can be removed from an article during the recycling process, i.e. during washing process of an article. The article may be reusable or recyclable, such as a glass bottle, a plastic bottle or other container. The washing process may comprise a washing liquid e.g. an alkaline water solution. The solution may contain e.g. 0.5-10% caustic soda, in particular 1-5% caustic soda (by weight). The temperature of the washing liquid may be e.g. higher than or equal to 60° C., preferably in the range of 80-85° C. During washing process the label may be exposed to washing liquid and the adhesive layer 4 may be lose the adhesive force, and the label may be detached from the surface 7.

In practical washing tests carried out at a temperature of 80° C. in a 1.5% dilute caustic soda solution, it has been observed that label samples produced in the manner described above are washable from the surface of the items, such as bottles, in times of less than 60 seconds, which matches perfectly with practical requirements. The washing tests were also carried out at a temperature of 66° C. in 4.5% dilute caustic soda solution. Labels may be removed from the surface in time of less than 90 seconds, preferably in time around 60 seconds.

Under washing conditions there may be several changes in morphology of the regenerated cellulose, which will further cause changes in the dimensional stability of the labels. These changes in dimensional stability are normally of the order of approximately 2-3%. These changes in the regenerated cellulose film result in a curling of the labels which then enables the caustic soda solution to wash the labels off from the bottle.

In order to control an amount of curling of the label there should be a controlled shrinkage of the label during washing process. Cellophane films may have shrinkage in machine direction of less than 5%, preferably less than 3%, and most preferably from 1 to 2%, which enables a controlled and adequate curling of the label comprising a cellophane. The shrinkage in machine direction of laminates comprising cellulosic film may be less than 5%, preferably less than 3%, and most preferably from 1 to 2%.

In addition, due to the high water absorption property of the regenerated cellulose film, there may be a positive change in the thickness of the film. It may be advantageous in order give further stiffness for the label and enable the label to roll up and block up the washing equipment after removal from the article.

The properties of regenerated cellulose films and composite facestock laminates comprising regenerated cellulose film produced through xanthation process of dissolved cellulose pulp are to be illustrated in the following examples.

Example 1, Example 2, Example 3, and Example 4 refer to plain cellophane films having thickness of 45 microns. The films comprise 100% of regenerated cellulose. The films were immersed for 5 minutes in a washing solution having temperature of 80° C. and 1.5% NaOH or temperature of 66° C. and 4.5% NaOH or water 80° C. or 66° C., respectively. The change of length of 5 parallel samples was measured both in machine direction (MD) and in cross direction (CD) of the film.

Example 5, Example 6, Example 7, and Example 8 refer to laminates comprising biaxially oriented PP film and cellophane film. The thickness of the PP film is 25 microns and cellophane film 45 microns. The cellophane film comprises 100% of regenerated cellulose based on viscose process. The laminates were immersed for 5 minutes in a washing solution having temperature of 80° C. and 1.5% NaOH or temperature of 66° C. and 4.5% NaOH or water 80° C. or 66° C., respectively. The change of length of 5 parallel samples was measured both in machine direction (MD) and in cross direction (CD) of the film.

Test results of Examples 1-4 are presented in the following Table 1. Std refers to standard deviation. The negative shrinkage value refers to expansion of the sample.

TABLE 1
Shrinkage of the films and laminates
comprising regenerated cellulose.

| Shrinkage (%) | | |
|---|---|---|
| | | Average of the |
| MD | CD | MD and CD |

Regenerated cellulose film
Example 1/80° C., 1.5% NaOH

| | | | |
|---|---|---|---|
| | 2.12 | −3.33 | −0.61 |
| | 1.82 | −3.33 | −0.76 |
| | 2.12 | −3.33 | −0.61 |
| | 1.82 | −3.03 | −0.61 |
| | 1.82 | −3.33 | −0.76 |
| Average | 1.94 | −3.27 | −0.67 |
| std | 0.17 | 0.14 | 0.08 |

Example 2/66° C., 4.5% NaOH

| | | | |
|---|---|---|---|
| | 1.82 | −3.03 | −0.61 |
| | 1.82 | −2.42 | −0.30 |
| | 1.82 | −2.42 | −0.30 |
| | 1.82 | −2.42 | −0.30 |
| | 1.82 | −2.42 | −0.30 |
| Average | 1.82 | −2.55 | −0.36 |
| std | 0.00 | 0.27 | 0.14 |

Example 3/water 80° C.

| | | | |
|---|---|---|---|
| | 1.82 | −3.33 | −0.76 |
| | 1.82 | −3.03 | −0.61 |
| | 1.82 | −3.33 | −0.76 |
| | 1.52 | −3.03 | −0.76 |
| | 1.82 | −3.03 | −0.61 |
| Average | 1.76 | −3.15 | −0.70 |
| std | 0.14 | 0.17 | 0.08 |

Example 4/water 66° C.

| | | | |
|---|---|---|---|
| | 1.52 | −3.03 | −0.76 |
| | 1.21 | −3.03 | −0.91 |
| | 1.52 | −2.42 | −0.45 |
| | 1.52 | −3.03 | −0.76 |
| | 1.52 | −3.03 | −0.76 |
| Average | 1.45 | −2.91 | −0.73 |
| std | 0.14 | 0.27 | 0.17 |

Laminate
Example 5/80° C., 1.5% NaOH

| | | | |
|---|---|---|---|
| | 1.21 | −0.61 | 0.30 |
| | 1.21 | 0.00 | 0.61 |
| | 1.21 | −0.61 | 0.30 |
| | −0.61 | −0.30 | −0.46 |
| | 1.21 | −0.61 | 0.30 |
| Average | 0.85 | −0.42 | 0.21 |
| std | 0.81 | 0.27 | 0.39 |

Example 6/66° C., 4.5% NaOH

| | | | |
|---|---|---|---|
| | 1.82 | −0.61 | 0.61 |
| | 1.21 | −0.61 | 0.30 |
| | 1.21 | −0.91 | 0.15 |
| | 1.82 | −0.91 | 0.45 |
| | 1.21 | −0.91 | 0.15 |
| Average | 1.45 | −0.79 | 0.33 |
| std | 0.33 | 0.17 | 0.20 |

Example 7, water 80° C.

| | | | |
|---|---|---|---|
| | 1.21 | −0.61 | 0.30 |
| | 1.21 | −0.30 | 0.46 |
| | 1.21 | −0.30 | 0.46 |
| | 1.21 | −0.30 | 0.46 |
| | 1.21 | −0.30 | 0.46 |
| Average | 1.21 | −0.36 | 0.42 |
| std | 0.00 | 0.14 | 0.07 |

Example 8, water 66° C.

| | | | |
|---|---|---|---|
| | 0.61 | 0.00 | |
| | 0.61 | 0.00 | |
| | 0.61 | 0.00 | |
| | 0.61 | 0.00 | |
| | 0.61 | 0.00 | |
| Average | 0.61 | 0 | 0.61 |
| std | 0 | 0 | |

It is an advantage that a cellulosic film, i.e. film comprising a regenerated cellulose is expanding in CD direction of the film despite the change in washing conditions. The expansion of the film is from 1 to 5%, preferably from 2 to 4%, and most preferably from 2.5 to 3.5%. The shrinkage of the film in the machine direction (MD) is also substantially independent on the washing conditions. The shrinkage of the film is substantially same in washing conditions having temperature of 80° C. and 1.5% NaOH compared to washing conditions having temperature of 66° C. and 4.5% NaOH. The shrinkage of the film in lower temperature (66° C.) washing conditions is from 50 to 120%, preferably from 65 to 110%, and most preferably from 75 to 100% from the shrinkage in higher temperature washing conditions (80° C.). The total shrinkage of regenerated cellulose film may also be negative i.e. the cellulosic film expands. The total shrinkage means the average shrinkage of the film in MD and CD direction, in direction SX and SY respectively, shown in the FIG. 2b.

It is also advantageous that, the label laminate structures comprising a regenerated cellulose film are stable or expanding in CD direction of the laminate despite the change in washing conditions (washing temperature and amount of NaOH). Preferably the laminates are expanding. The laminates may have expansion from 0 to 5%, preferably from 0 to 3.5, and most preferably from 0.2-1.5%. The shrinkage of the laminate structure in the machine direction (MD) is also substantially independent on the washing conditions having temperature of 80° C. and 1.5% NaOH or having temperature of 66° C. and 4.5% NaOH. The shrinkage of the laminate in lower temperature (66° C.) washing conditions is from 50 to 200%, preferably from 65 to 190%, and most preferably from 75 to 180% from the shrinkage of the laminate structure in higher temperature washing conditions (80° C.). Also average shrinkage, i.e. total shrinkage, of the label laminate comprising regenerated cellulose film, such as cellophane, is preferably less than 1%. The average shrinkage value may even be negative, if there exists more expansion in CD direction than shrinkage in MD direction.

It is a further advantage, that by the addition of cellulosic film, such as cellophane film the stiffness of the laminate is increased. The stiffness of the laminate is beneficial for the dispensing properties of the label during the label application to the articles, such as bottles.

Due to the stiffness of the cellophane, it is possible to reduce the thickness of the PP film and thus provide laminates with reduced overall thickness. For example, labels having regenerated cellulose film may comprise PP film having thickness of 15 microns. Preferably the bending stiffness of the laminated label structure comprising cellulosic film and PP film is at least 0.07 mNm in machine direction (MD). In cross direction (CD) the bending stiffness of the laminated label structure may be at least 0.06 mNm.

Table 2 provides bending stiffness values in machine direction (MD) and in cross direction (CD) for a pure cellophane film having thickness of 45 microns, polypropylene film having thickness of 15 or 25 microns, and laminate comprising a cellophane film having thickness of 45 microns and PP film having thickness of 15 or 25 microns. Following test parameters were used: bending angle 15° and bending length 5 mm.

TABLE 2
Bending stiffness values for different films and laminates.

Bending stiffness (mNm)

| | MD | CD |
|---|---|---|
| Cellophane45 | 0.05 | 0.03 |
| PP15 | 0 | 0 |
| PP25 | 0.003 | 0.005 |
| Cellophane45/PP15 | 0.07 | 0.06 |
| Cellophane45/PP25 | 0.10 | 0.11 |

Labels comprising a laminated structure including a regenerated cellulose film can be used for labelling different type of containers, typically re-usable containers such as beverage containers such as bottles, in particular glass bottles for soft drinks or beer.

The various aspects of the invention are illustrated by the following examples.

### Example 1

A web of label laminate for wash off labels comprising a layer of regenerated cellulose film.

### Example 2

The web of label laminate according to example 1, wherein the layer of regenerated cellulose is laminated to a polypropylene film of a base laminate construction.

### Example 3

A wash off label product comprising a layer of regenerated cellulose film.

### Example 4

The wash off label product according to example 3, wherein the layer of regenerated cellulose is laminated to a polypropylene film.

The embodiments described above are only example embodiments of the invention and a person skilled in the art recognizes readily that they may be combined in various ways to generate further embodiments without deviating from the basic underlying invention.

1. A label which is removable from an article during a washing process, the label comprising:
a facestock layer and an adhesive layer against one side of the facestock layer, the facestock layer including a biaxially oriented polypropylene film and an overlamination on another side of the facestock layer by a plastic film layer comprising at least 60 weight-% of regenerated cellulose, wherein the plastic film layer has shrinkage in a machine direction and expansion in a cross direction of the label so that the label is removable from the article during the washing process.

2. The label according to claim 1, wherein the plastic film layer comprises at least 85 weight-% of regenerated cellulose.

3. The label according to claim 1, wherein the plastic film layer comprises at least 95 weight-% of regenerated cellulose.

4. The label according to claim 1, wherein the regenerated cellulose is based on a viscose process.

5. The label according to claim 4, wherein the regenerated cellulose is cellophane.

6. The label according to claim 1, wherein the plastic film layer is oriented.

7. The label according to claim 1, wherein the facestock layer comprises a biaxially oriented polypropylene film having a thickness from 15 to 50 microns.

8. The label according to claim 1, wherein the plastic film layer has shrinkage of less than 5% in a machine direction of the label.

9. The label according to claim 1, wherein the plastic film layer has expansion from 1 to 5% in a cross direction of the label.

10. The label according to claim 1, wherein the shrinkage of the plastic film in washing conditions having temperature of 66° C. and 4.5% NaOH is from 50 to 120% from the shrinkage of the plastic film in washing conditions having temperature of 80° C. and 1,5% NaOH.

11. The label according to claim 1, wherein the label has expansion from 0 to 5%.

12. The label according to claim 1, wherein the shrinkage of the label in washing conditions having temperature of 66° C. and 4.5% NaOH is from 50 to 200%, from the shrinkage of the label in washing conditions having temperature of 80° C. and 1.5% NaOH.

13. The label according to claim 1, wherein the label has average shrinkage of the machine direction and cross direction less than 1%.

14. A method for producing a laminated label structure, the method comprising:
combining an adhesive layer to a release liner and to one side of a face material layer;
overlaminating another side of the face material layer by a plastic film layer comprising regenerated cellulose so as to form a laminated label structure.

15. The method of claim 14 further comprising cutting the laminated structure so as to form labels.

16. (canceled)

17. A method of adhering a label comprising labelling recyclable or re-usable articles with the label according to claim 1, wherein the label is subsequently removed during a washing-off process.
